(19) United States
(12) Patent Application Publication
(10) Pub. No.: US 2024/0149231 A1
(43) Pub. Date: May 9, 2024

(54) APPARATUS AND METHODS FOR MIXING VISCOUS FLUIDS THROUGH ROTATIONAL AND SHAKING MOTIONS

(71) Applicant: THE REGENTS OF THE UNIVERSITY OF CALIFORNIA, Oakland, CA (US)

(72) Inventors: Stavros Vougioukas, Davis, CA (US); Dennis Sadowski, Davis, CA (US); Zhenghao Fei, Davis, CA (US)

(73) Assignee: THE REGENTS OF THE UNIVERSITY OF CALIFORNIA, Oakland, CA (US)

(21) Appl. No.: 18/528,266

(22) Filed: Dec. 4, 2023

Related U.S. Application Data
(63) Continuation of application No. PCT/US2022/032717, filed on Jun. 8, 2022.
(60) Provisional application No. 63/208,103, filed on Jun. 8, 2021.

(51) Int. Cl. B01F 29/33; B01F 29/34; B01F 29/60; B01F 31/24; B01F 31/25; B01F 35/42

(52) U.S. Cl. CPC B01F 29/33; B01F 29/34; B01F 29/60; B01F 31/24; B01F 31/25; B01F 35/42

(57) ABSTRACT

An apparatus for mixing viscous fluids in a container through applied rotational and oscillation motions is provided. The apparatus has a sample carrier platform mounted to a shaft along a longitudinal axis with a first mechanism imparting oscillating motion to the shaft and a second mechanism imparting rotational motion to the shaft and carrier platform along the axis simultaneously or sequentially. Couplings to the shaft allow the shaft to freely rotate at the same time as it can be pushed or pulled along the longitudinal axis. Sequence, duration and frequency of oscillations and rotations are controlled with a programmable controller.

### CROSS-REFERENCE TO RELATED APPLICATIONS

This application claims priority to, and is a 35 U.S.C. § 111(a) continuation of, PCT international application number PCT/US2022/032717 filed on Jun. 8, 2022, incorporated herein by reference in its entirety, which claims priority to, and the benefit of, U.S. provisional patent application Ser. No. 63/208,103 filed on Jun. 8, 2021, incorporated herein by reference in its entirety. Priority is claimed to each of the foregoing applications.

The above-referenced PCT international application was published as PCT International Publication No. WO 2022/261242 on Dec. 15, 2022, which publication is incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to automated fluid sample mixing and processing systems and methods, and more particularly to a laboratory fluid sample mixing apparatus and system that both oscillates and rotates samples at controllable rates and durations.

### 2. Background

Many laboratory testing procedures require the processing of samples in aqueous solution or samples in an aqueous solution combined with an immiscible organic solvent. For example, some procedures require the mixing and separation of organic solvents from an aqueous solution after a specific period of time of mixing. Other procedures require fully mixing viscous liquids such as saliva with an enzyme or other reactant. Consequently, the samples need to be vigorously shaken and regularly inverted in order to mix the materials.

The conventional approach to mixing viscous liquids is for a person to individually shake and rotate (i.e., invert) each tray of samples. This approach, however, leads to inconsistencies in the degree of mixing and can create a bottleneck when attempting to process thousands of samples each day. Shaking and inverting procedures also creates repetitive strains on the technicians.

Other laboratory processes require some uniformity and control over the rate of oscillation of the sample, the intensity of agitation of the sample and the duration of sample mixing to produce reliable and predictable test results. Control over these mixing conditions may be limited and vary from individual to individual if the process is performed by hand. Therefore, there is a need for an apparatus that can automatically rotate and shake samples for consistent and high-speed processing.

### BRIEF SUMMARY

An apparatus configured to shake and invert containers of high viscosity fluids, such as multiple trays containing vials of samples, is provided with oscillations and rotations of controllable intensity, frequency and duration. The apparatus may be adapted to any procedure where mixing of viscous or immiscible liquids in small containers is needed.

At the center of one embodiment of the apparatus is a sample platform that has upper and lower surfaces that are configured to hold one or more sample trays that are held in position by clamps, illustrated by hinged clamping bars. The clamping bars lock down the sample trays to the platform so that there is no movement of the trays with respect to the platform during translational or rotational motions of the platform. Each tray can hold multiple sample vials and the apparatus can hold multiple trays at the same time. The configuration is scalable to hold any desired number of trays. Although the apparatus is illustrated with trays of small containers, the apparatus can alternatively be configured to hold other types of containers such as cans or sealed flasks that are not in a tray. Likewise, the clamping or fixing mechanism for securing the sample tray or container to one or both sides of the carrier platform can be brackets, sockets or similar mounts known in the art.

One important feature of the apparatus is a crank-slider mechanism, which operates in a single plane, that is attached to a platform which allows the platform to both oscillate and rotate. This functionality is provided by an enclosed coupling mounted on the crank-slider end of the platform shaft and a dual-prong sliding coupling mounted on the rotational motor end of the shaft. The special enclosed coupling allows the shaft to freely rotate at the same time as the shaft can be pushed or pulled along the longitudinal axis. The dual-prong sliding coupling allows the shaft to translate freely at the same time as it is rotated by the rotational motor.

Both the translational motor which induces translational vibration and the rotational motor which rotates the carrier are preferably mounted on to a fixed frame, so that only the carrier platform, which holds the sample trays or containers, oscillates and rotates. This reduces the weight and complexity of the carrier platform as well as allows for the use of a smaller crank-slider motor.

In an illustration for Covid-19 testing, individual trays are loaded and locked into place on a carrier platform. The carrier platform is mounted on linear bearings and attached to both a motorized slider-crank mechanism and a motor which can rotate the carrier. The slider-crank mechanism causes the carrier to move back and forth along the longitudinal axis of the carrier. The degree of movement or amplitude can be altered by a simple adjustment. The carrier platform can also rotate about its longitudinal axis and stop at preset orientations.

The apparatus controller can be programmed to oscillate (i.e., shake) and rotate the carrier in various desired sequences, durations and frequencies. For example, testing showed that Covid-19 saliva samples were well mixed with the enzyme papain if the vials were subjected to the following cycle: shake for 3 seconds at a frequency of 4 Hz and peak-to-peak amplitude of 1 centimeter, then rotate 180 degrees to invert the tubes and repeating this sequence 60 times and then stop.

An Arduino micro-controller, for example, can be programmed and reprogrammed to alter the variables and timing of the cycles to accommodate other types of high viscosity fluids. The ease with which variables can be changed facilitates optimization of the mixing parameters for given compositions of fluids or suspensions.

Accordingly, aspects of the apparatus include, but are not limited to, providing for mixing of high viscosity fluids, shaking and rotation by inversion of containers to mix high viscosity fluids, mixing multiple samples, and automating the degree of mixing in a repeatable manner.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 is a front perspective view of an apparatus for imparting rotational and shaking motion to a carrier according to an embodiment of the subject technology.

FIG. 2 is an exploded view of the apparatus of FIG. 1 showing crank-slider and rotational mechanisms and portions of the platform assembly.

FIG. 3 is an exploded view of the apparatus of FIG. 1 and FIG. 2 showing portions of the platform assembly and the frame.

FIG. 4 is an exploded view of an embodiment of the apparatus illustrating parts details.

### DETAILED DESCRIPTION

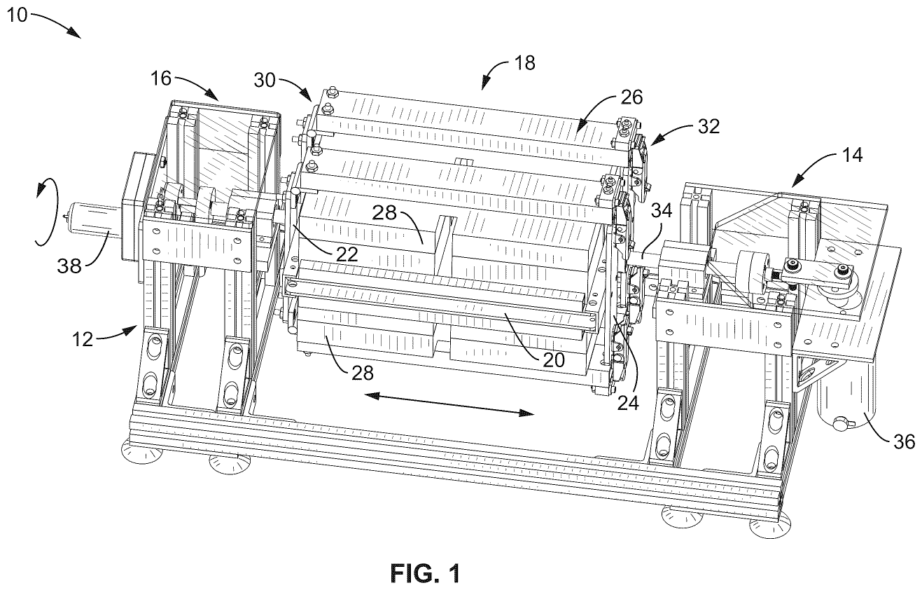

Referring more specifically to the drawings, for illustrative purposes an embodiment of an apparatus according to the subject technology is generally shown in FIG. 1 through FIG. 4. It will be appreciated that the apparatus may vary as to configuration and as to details of the components, and that the method of use may vary as to the specific steps and sequence of operation, without departing from the basic concepts as disclosed herein.

The subject apparatus can rotate and oscillate multiple trays of samples at the same time and will process each batch of samples exactly the same way for more consistent results. Once loaded and activated, no further supervision of the apparatus by the operator is required. The apparatus will go through its pre-programmed cycle and stop automatically when completed.

Turning now to FIG. 1, one apparatus 10 for uniformly shaking and inverting a set of samples in sample trays is generally shown. The apparatus 10 has a frame 12 with a crank slider mechanism 14 and a rotational mechanism 16. The platform assembly 18 in this embodiment has a sample carrier platform 20 with an upper surface and a lower surface for receiving sample trays or containers. The platform assembly 18 also has left-side and right-side panels 22, 24 mounted orthogonally to the plane of the platform 20 with a hinged sample retaining bar 26 that folds over and latch to retain one or more sample trays 28 to the carrier platform 20.

In the embodiment shown in FIG. 1, the elongate sample retaining bar 26 is hinged at one end to the left-side panel 22 with a hinge 30 and has a latch 32 at the other end to lock with the bar 26 with the right-side panel 24. Each sample retaining bar 26 exerts pressure on one or more sample trays 28 to restrict movement of the tray when the bar 26 is latched.

The platform assembly 18 also has an axial shaft 34 mounted centrally along the plane of the carrier platform 20. The axial shaft 34 generally has a crank slider mechanism 14 end and a rotational mechanism 16 end with couplings that allow both linear oscillation and rotation of the platform 20 through these mechanisms. Only the platform assembly 18, that holds the sample trays 28, oscillates and rotates because the crank slider mechanism 14 that induces translation oscillations and the rotational mechanism components that rotate the platform 20 are mounted to a fixed frame 12.

The direction of the side-to-side linear movement of the platform assembly 18 that is produced by the crank slider mechanism motor 36 is shown in FIG. 1 with an arrow. The rotational motion of the platform assembly 18 that is produced by the rotation mechanism motor 38 is shown with a circular arrow. The crank-slider mechanism motor 36 and the rotation mechanism motor 38 may include wired or wireless control over the actuation of the motor as well as the rate of rotation of each of the motor outputs and duration. The controller may have programming, such as that shown in Table 1 to Table 3, to control the mixing parameters and to provide optimum mixing conditions for the specific fluids to be mixed. The controller can activate the crank-slider mechanism and the rotation mechanism sequentially or simultaneously to produce a oscillating/shaking motion, a rotational motion, or simultaneous oscillating/shaking motion and rotational motion, as well as sequenced shaking and rotational motions.

An important feature of the apparatus is the axial shaft 34 coupled to a crank-slider mechanism, which operates in a single plane, and to the rotation mechanism, which allows the platform to both oscillate and rotate.

The ability of the platform assembly 18 of the apparatus to both oscillate and rotate is provided by an enclosed coupling that is mounted on the crank-slider end of the platform shaft 34 and a dual-prong/pin sliding coupling mounted on the rotational motor 38 end of the shaft 34. The special enclosed coupling allows the shaft 34 to freely rotate at the same time as it is pushed or pulled by the crank-slider mechanism 14. Furthermore, the dual-prong sliding coupling allows the shaft 34 to translate freely at the same time as it can be rotated by the rotational motor 38.

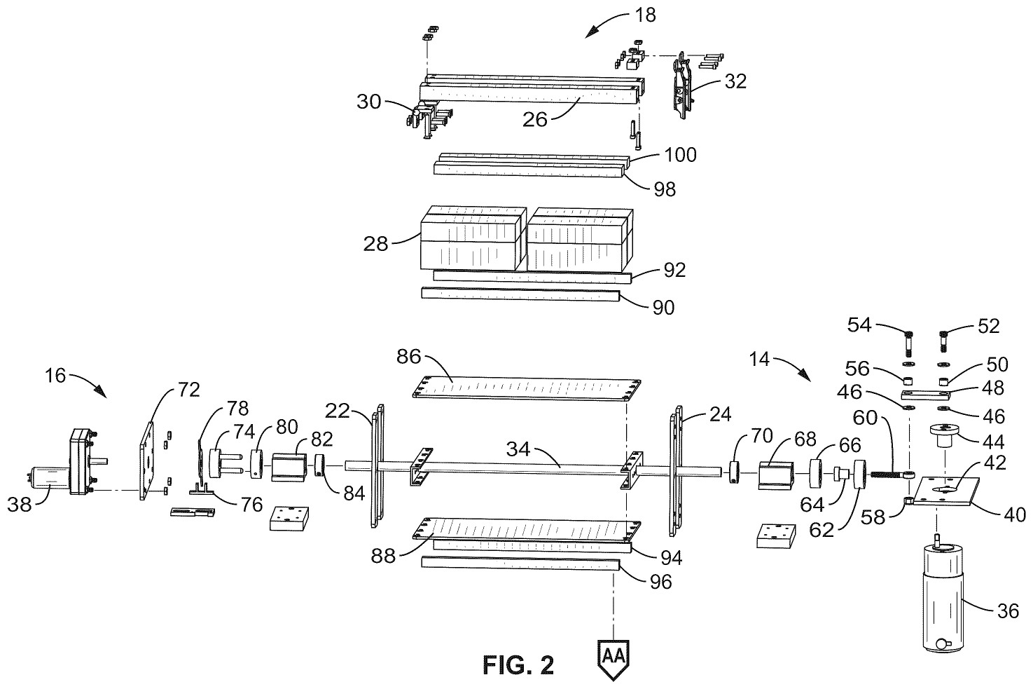

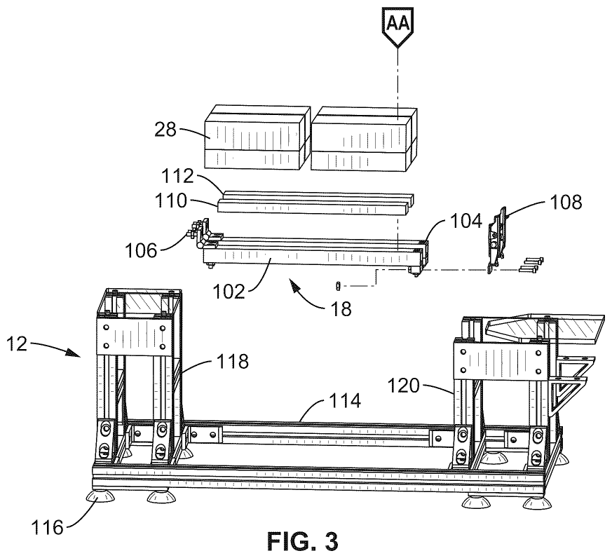

The crank-slider mechanism 14, rotational mechanism 16 and platform assembly 18 can be seen in greater detail in the exploded views of FIG. 2 and FIG. 3. The linkage of the crank-slider mechanism 14 has a vertically oriented motor 36 with oscillating carriage coupled to one of the ends of shaft 34. The oscillating carriage has a shaker motor mounting plate 40 with an opening 42 that receives crank disk 44. The output shaft of the crank slider motor 36 is operably coupled to one end of a crank plate 48 through the crank disk 44, upper and lower thrust bearing 46, needle roller bearing 50 with a shoulder bolt 52. The distal end of the crank plate 48 is operably coupled to the eye of a threaded rod end bolt 60 with a needle roller bearing 56 and nut 58. The threaded rod end bolt 60 is coupled to one end of the axial shaft 34 with a retaining ring 62, rotation cap 64, shaft endpiece 66. The end of the shaft 34 is preferably disposed within a linear sleeve bearing 68 with support block and limited by shaft collar 70. It can be seen that the rotation of the motor produces a linear motion in the threaded rod end bolt 54 to the axial shaft 34 through this linkage.

The details of the preferred embodiment of the rotational mechanism 16 are also apparent in the exploded view of FIG. 2. The rotation motor 38 is mounted to a motor mounting plate 72 with mounting hardware and the output of motor 38 is coupled to a two-prong shaft collar 74. In this embodiment, an infrared diode sensor 76 and support block and photo interrupt plate 78 are provided for positional control of the rotation. The two-prong shaft collar 74 can engage a corresponding shaft collar 80 that will engage the pins/prongs and end of the axial shaft 34 that is supported by a linear sleeve bearing 82 with support block and shaft collar 84.

The components of the platform assembly 18 of the apparatus 10 are also shown in the exploded views of FIG. 2 and FIG. 3. In the embodiment shown, the sample platform 20 is made from upper panel 86 and a lower panel 88 that sandwich the axial shaft 34. The sample platform 20 has a pair of rails 90, 92 mounted along the long edges of the upper panel 86 forming a wall to retain the sample trays 28 on the platform surface. Likewise, the lower panel 88 of the sample platform 20 has a pair of rails 94, 96 on the long edges that retain the sample trays 28 on the lower surface of the platform 20.

The sample trays 28 are also held in place with hinged retaining bars 26 that apply pressure on the sample trays from the top. In the platform assembly 18 embodiment shown, two top retaining bars 26 are mounted to the upper end of left-side panel 22 with hinges 30 mounted with mounting bolts and hardware to the one end of each retaining bar 26. A latch 32 is mounted with mounting bolts and hardware to the opposite end of each retaining bar 26. The latch 32 has a locking member mounted to the top end of the right-side panel 24. This configuration allows the efficient placement of the sample trays 28 onto the platform surface 86 and the retaining bars 26 to be maneuvered into place and latched. Each of the top retaining bars 26 has a resilient pad 98, 100, such as a sponge rubber pad, which engages the top of the sample trays 28 to hold them in place when the platform 20 is inverted during use.

As seen as seen in FIG. 3, the platform assembly 18 is symmetrical with corresponding mirrored structures in the lower platform as found in the upper platform portion. A pair of bottom retaining bars 102, 104 are provided with elongate resilient pads 110, 112 that engage the sample trays 28. Each of the bottom retaining bars 102, 104 are mounted to the lower end of the left-side panels 22 with hinges 106. Latches 108 are mounted with mounting hardware to each bottom retaining bar 102, 104 at the end opposite the hinge with latch member also to the bottom end of each of the right-side panels 24.

The frame 12 preferably has a base 114 with feet 116 that resist movement of the apparatus during use. In the embodiment shown in FIG. 3, the base 114 has a first vertical support column 118 that supports the left side panels and rotation mechanism 16 components. The base 114 also has a second vertical support column 120 that supports the left side panels and crank-slider mechanism 14 components. The platform assembly 18 can quickly and freely move back and forth between support columns 118, 120 and rotate at the same time.

The technology described herein may be better understood with reference to the accompanying examples, which are intended for purposes of illustration only and should not be construed as in any sense limiting the scope of the technology described herein as defined in the claims appended hereto.

### EXAMPLE 1

In order to demonstrate the functionality of the system and methods, one embodiment of the sample mixing apparatus and system was constructed and tested. The apparatus was constructed with the components shown in FIG. 1 to FIG. 3 and the mixing functionality of the apparatus was evaluated. The sample trays were held in place by clamping bars which were padded on the underside. The clamping bars could swing open via hinges and could be latched in the closed position with a latch. The carrier platform was securely attached to the axial shaft which approximately runs the length of the apparatus with a rotation mechanism on one end and an oscillating mechanism on the other end. The axial shaft and the attached carrier platform could slide laterally back and forth in the linear bearings, and it could also rotate about its longitudinal axis. The crank-slider mechanism was attached to the axial shaft by a shaft endplate and a retaining collar.

As shown in FIG. 2, a rotation cap fixed to the end of the axial shaft was sandwiched between the shaft endplate and a retaining collar. The rotation cap had a larger diameter than the shaft and was captured in a cavity in the shaft endplate. This arrangement allowed the axial shaft to be pushed and pulled by the crank-slider mechanism while still allowing the shaft to freely rotate about its longitudinal axis. Rotation of the crank-slider motor created a reciprocating motion in the crank-slider mechanism. This motion was transferred to the shaft and thus the carrier platform as well as to the sample trays mounted on the carrier platform.

The amplitude of the reciprocating motion could be determined by the distance between the axis of rotation of the crank-slider motor 36 and the connection point of the linkage bar 48 in the crank-slider mechanism. This distance, and thus the amplitude, can be altered by changing the position of the connection point.

Mounted on the opposite end of the shaft was a collar for pins that was part of the rotation mechanism. This collar 80 had two holes which was able to accept the two pins on the two-prong shaft collar 74 in a free sliding fit. The two-prong shaft collar was mounted on the output shaft of a spit motor. The spit motor could rotate the shaft and the attached carrier platform by a transfer of torque between the two pins on the shaft collar and the engaging collar 80. This arrangement allowed the shaft to move unhindered laterally as well as to rotate about its long axis. The assembly was mounted on a rigid frame and the frame was held in place on a surface using suction cup feet.

### EXAMPLE 2

To further demonstrate the functionality of the apparatus and system, computer control over mixing parameters was evaluated. In this illustration, the rotational and shaking motion of the apparatus was controlled by a program written to single-board micro-controller, such as an Arduino. The controller was connected to the motors and other devices in the apparatus as necessary using standard wiring.

Tables 1 through 3 provide an example of computer program instructions for controlling the apparatus. The controller turned the motors on and off at the appropriate times. Two tabs were mounted 180° apart on the two-pronged shaft collar that can interrupt the beam of a small infrared sensor, which sent a signal to the controller to stop the rotation of the spit motor. This created an inversion of the sample trays after each shaking cycle. An embodiment of a typical operation sequence is as follows:
1. The operator opens the locking latches of the two upper clamping bars and swings the bars to the open position.
2. Up to four sample trays were placed on the upper surface of the carrier platform and the clamping bars are then swung closed and latched.
3. The operator presses the rotate button on the control box and the carrier platform will rotate 180° to expose the clamping bars on the opposite, (i.e., bottom side) of the carrier platform.
4. The operator repeats steps 1 and 2 to install up to four more sample trays on the carrier.
5. The operator then presses the Run/Shake button on the control box. This initiates the Run sequence and no further action is required by the operator until the sequence automatically ends.
6. The crank-slider motor turns on and creates a reciprocating lateral motion for about 3 seconds and then turns off.
7. Immediately after step 6, the spit motor turns on rotating the carrier platform by about 180°, and then turns off.
8. Steps 6 and 7 are automatically repeated 60 times (or some set multiple) and then the sequence ends.
9. The operator returns, opens the Clamping Bars, removes the upper set of Sample Trays, and closes and latches the Clamping Bars.
10. The operator presses the Rotate button and the Carrier will rotate 180° to expose the Clamping Bars on the opposite side of the Carrier.
11. The operator repeats step 9.
12. The apparatus is now ready to accept another batch of Sample Trays.

In another example, an Arduino micro-controller or other device can be programmed and reprogrammed to alter the variables and timing of the cycles to accommodate various types of high viscosity fluids. The ease with which variables can be changed facilitates optimization of the mixing parameters for a given fluid.

### EXAMPLE 3

The apparatus was configured to shake and rotate containers of high viscosity fluids, including multiple trays containing vials of saliva samples being tested for the presence of the corona virus. One important step in the testing process was mixing the viscous saliva samples with papain protease, an enzyme that makes these samples less sticky so they can be used in a pipette later in the process. To mix the enzyme evenly into the viscous and stringy saliva, the samples needed to be vigorously shaken and inverted.

In the Covid-19 testing setting, individual trays were loaded and locked into place on the top and bottom of the carrier platform. In this example, each tray could hold up to 96 samples and the apparatus that was evaluated could hold up to eight trays. Although the apparatus produced for testing could hold up to 8 trays, the apparatus can be scaled up to hold many more trays if desired. Furthermore, the carrier platform can also be adapted to hold other types of containers such as cans or sealed flasks in addition to vials.

As shown in FIG. 1 through FIG. 3, the carrier platform was mounted on linear bearings and was attached to both a motorized slider-crank mechanism and a rotation mechanism with a motor which can rotate the carrier platform. The slider-crank mechanism was used to cause the carrier platform to move back and forth along the longitudinal axis of the carrier platform. The degree of movement or amplitude could be altered by a simple adjustment. The carrier platform could also rotate about its longitudinal axis and stop at a preset orientation.

In this illustration, the apparatus was programmed to shake and rotate the carrier in various desired sequences. For example, testing has shown that Covid-19 saliva samples will be mixed well if the vials were subjected to the following cycle: shake for 3 seconds at a frequency of 4 Hz and peak-to-peak amplitude of 1 centimeter, then rotate 180 degrees to invert the tubes; repeat this sequence 60 times, then stop. Also, because variables such as shaking speed, duration, frequency of inversion, and timing can all be changed through simple software commands, the search for optimal mixing parameters is greatly facilitated.

### EXAMPLE 4

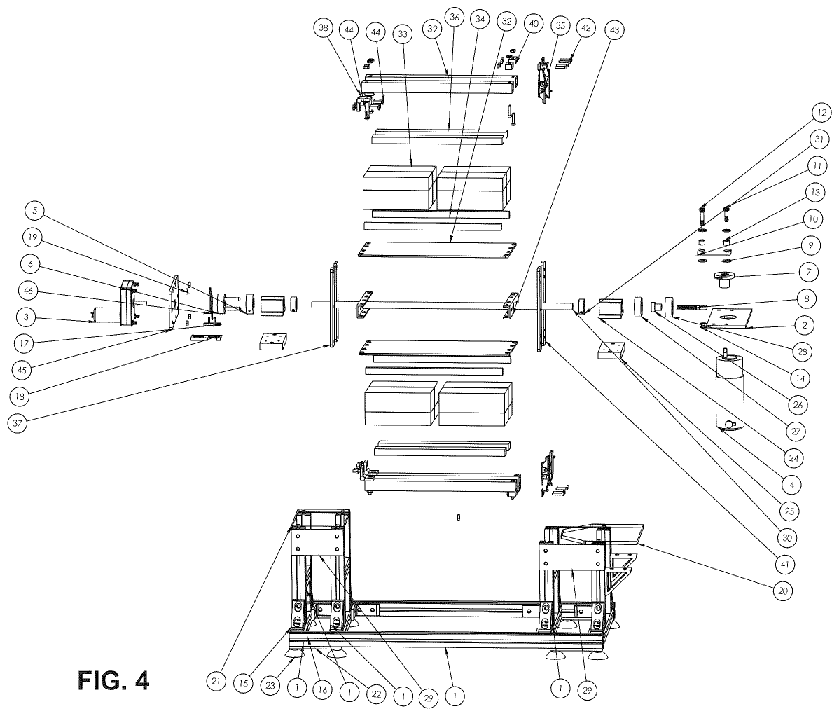

The apparatus shown in FIG. 4 illustrates an exemplary embodiment of the apparatus described above with details of the parts. The reference numbers contained in circles correspond to the parts shown in Table 4.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general-purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction (s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:
An apparatus for mixing fluids, comprising: (a) a carrier configured to retain one or more containers of fluids to be mixed; (b) a mechanism configured to oscillate the carrier along a longitudinal axis; (c) a mechanism configured to rotate the carrier around the longitudinal axis; and (d) a controller configured to control rotation and oscillation of the carrier.

The apparatus of any preceding or following implementation, wherein the mechanism configured to rotate the carrier along a longitudinal axis comprises: a shaft with a central longitudinal axis, the carrier mounted to the shaft; a rotational motor with an output; a coupling operably connected to the shaft and to the motor output, the coupling configured to rotate the shaft around its central longitudinal axis, the coupling configured to rotate the shaft while it oscillates between a first position and a second position along the longitudinal axis; wherein the coupling allows the shaft to translate freely at the same time as it is rotated by the rotational motor.

The apparatus of any preceding or following implementation, wherein the coupling comprises a dual-prong sliding coupling.

The apparatus of any preceding or following implementation, wherein the mechanism configured to oscillate the carrier along a longitudinal axis comprises: a shaft with a central longitudinal axis, the carrier mounted to the shaft; a motor with an output; and a coupling operably connected to the shaft and to the motor output, the coupling configured to oscillate the shaft along the longitudinal axis between a first position and a second position, the coupling configured to oscillate the shaft while the shaft rotates around the longitudinal axis.

The apparatus of any preceding or following implementation, wherein the coupling comprises a crank slider mechanism configured to move the shaft along the longitudinal axis between a first position and a second position; wherein the coupling allows the shaft to freely rotate at the same time as the shaft is moved linearly along the longitudinal axis by the motor output.

The apparatus of any preceding or following implementation, wherein the carrier comprises: a carrier platform with a top surface; and one or more clamps configured to secure the containers of fluids to be mixed to the top surface of the carrier platform; wherein oscillation or rotation of the carrier platform will impart motion to the fluids to mix the fluids within the containers.

The apparatus of any preceding or following implementation, wherein the carrier comprises a carrier platform with a top surface and a bottom surface; one or more clamps configured to secure the containers of fluids to be mixed to the top surface of the carrier platform; and one or more clamps configured to secure the containers of fluids to be mixed to the bottom surface of the carrier platform; wherein oscillation or rotation of the carrier platform will impart motion to the fluids to mix the fluids within the containers.

The apparatus of any preceding or following implementation, wherein the clamp comprises at least one left side wall coupled to the platform; at least one right side wall coupled to the platform; and one or more elongate clamping bars coupled at one end to a side wall with a hinge and to an opposing side wall with a latch; wherein latching of each clamping bar is configured to secure the one or more containers to the top surface of the platform.

The apparatus of any preceding or following implementation, wherein the clamp comprises at least one left side wall coupled to the platform; at least one right side wall coupled to the platform; and one or more first elongate clamping bars coupled at one end to a side wall with a hinge and to an opposing side wall with a latch; one or more second elongate clamping bars coupled at one end to a side wall with a hinge and to an opposing side wall with a latch; wherein latching of each of the first clamping bars is configured to secure the one or more containers to the top surface of the platform; and wherein latching of each of the second clamping bars is configured to secure the one or more containers to the bottom surface of the platform.

The apparatus of any preceding or following implementation, wherein the controller controls motion of the carrier, the motion selected from the group consisting of oscillation motion, rotational motion, simultaneous oscillation motion and rotational motion, and sequenced oscillation and rotational motion.

An apparatus for mixing viscous fluids through rotational and oscillating motions, the apparatus comprising (a) a carrier platform with top and bottom surfaces with clamps configured to retain enclosed trays containing a plurality of containers with fluids to be mixed on the top and bottom surfaces of the carrier platform; (b) a mechanism configured to impart rotational motion to the carrier platform around a longitudinal axis for rotation of the carrier platform; (c) a mechanism configured to impart oscillating motion to the carrier platform along the longitudinal axis; and (d) a controller configured to control degree of rotational and oscillating motions of the carrier; (e) wherein the controller is programmable to oscillate and rotate the carrier platform in various desired sequences, durations and frequencies.

The apparatus of any preceding or following implementation, wherein the mechanism configured to rotate the carrier along a longitudinal axis comprises a shaft with a central longitudinal axis, the carrier mounted to the shaft; a rotational motor with an output; a coupling operably connected to the shaft and to the motor output, the coupling configured to rotate the shaft around its central longitudinal axis, the coupling configured to rotate the shaft while it oscillates between a first position and a second position along the longitudinal axis wherein the coupling allows the shaft to translate freely at the same time as it is rotated by the rotational motor.

The apparatus of any preceding or following implementation, wherein the mechanism configured to oscillate the carrier along a longitudinal axis comprises a shaft with a central longitudinal axis, the carrier mounted to the shaft; a motor with an output; a coupling operably connected to the shaft and to the motor output, the coupling configured to oscillate the shaft along the longitudinal axis between a first position and a second position, the coupling configured to oscillate the shaft while the shaft rotates around the longitudinal axis.

The apparatus of any preceding or following implementation, wherein the coupling comprises a crank slider mechanism configured to move the shaft along the longitudinal axis between a first position and a second position; wherein the coupling allows the shaft to freely rotate at the same time as the shaft is moved linearly along the longitudinal axis by the motor output.

An apparatus for mixing viscous fluids through rotational and oscillating motions, the apparatus comprising (a) a carrier configured to retain a plurality of containers with liquid samples to be mixed; (b) a shaft with a central longitudinal axis, the carrier mounted to the shaft; (c) a rotation coupling operably connected to a first end of the shaft and to a rotational motor output, the rotation coupling configured to rotate the shaft around its central longitudinal axis; (d) a translation coupling operably connected to a second end of the shaft and to a translation motor output, the translation coupling configured to oscillate the shaft along the longitudinal axis between a first position and a second position; and (e) a controller configured to control rotational and oscillating motions of the shaft; (f) wherein the rotation coupling is configured to rotate the shaft while it oscillates between a first position and a second position along the longitudinal axis; and (g) wherein the translation coupling is configured to oscillate the shaft while the shaft rotates around the longitudinal axis.

The apparatus of any preceding or following implementation, wherein the controller controls motion of the carrier, the motion selected from the group consisting of oscillation motion, rotational motion, simultaneous oscillation motion and rotational motion, and sequenced oscillation and rotational motion.

The apparatus of any preceding or following implementation, wherein the carrier comprises a carrier platform with a top surface; and one or more clamps configured to secure the containers of fluids to be mixed to the top surface of the carrier platform; wherein oscillation or rotation of the carrier platform will impart motion to the fluids to mix the fluids within the containers.

The apparatus of any preceding or following implementation, wherein the carrier comprises a carrier platform with a top surface and a bottom surface; one or more clamps configured to secure the containers of fluids to be mixed to the top surface of the carrier platform; and one or more clamps configured to secure the containers of fluids to be mixed to the bottom surface of the carrier platform; wherein oscillation or rotation of the carrier platform will impart motion to the fluids to mix the fluids within the containers.

A method of mixing viscous fluids through rotational and shaking motion, the method comprising: (a) providing the apparatus of any of any preceding or following implementation; and (b) imparting motion to the carrier wherein the motion is selected from the group consisting of oscillating motion, rotational motion, simultaneous oscillation motion and rotational motion, and sequenced oscillating and rotational motion.

An apparatus for mixing viscous fluids through rotational and shaking motion, the apparatus comprising: (a) a carrier configured to retain a plurality of containers with samples to be mixed; (b) a mechanism configured to impart motion to the carrier around a longitudinal axis for rotation of the carrier; (c) a mechanism configured to impart motion to the carrier along the longitudinal axis for shaking the carrier; and (d) a controller configured to control rotational and shaking motion of the carrier.

An apparatus for mixing viscous fluids through rotational and shaking motion, the apparatus comprising: (a) a carrier configured to retain a plurality of containers with samples to be mixed; (b) a mechanism configured to impart motion to the carrier around a longitudinal axis for rotation of the carrier; (c) a mechanism configured to impart motion to the carrier along the longitudinal axis for shaking the carrier; and (d) a controller configured to control degree of rotational and shaking motion of the carrier; (e) wherein the controller is programmable to shake and rotate the carrier in various desired sequences.

An apparatus for mixing viscous fluids through rotational and shaking motion, the apparatus comprising: (a) a carrier configured to retain a plurality of containers with samples to be mixed; (b) a motorized slider-crank mechanism coupled to the carrier; (c) a motor coupled to the carrier; (d) wherein the motor is configured to rotate the carrier; (e) wherein the slider-crank mechanism is configured to cause the carrier to move back and forth along a longitudinal axis of the carrier; and (f) a controller configured to control degree of rotational and shaking motion of the carrier; (g) wherein the controller is programmable to shake and rotate the carrier in various desired sequences.

As used herein, term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these group elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

Relational terms such as first and second, top and bottom, upper and lower, left and right, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has. . . a”, “includes . . . a”, “contains . . . a” does not, without more constraints, preclude the existence of additional identical elements in the process, method, article, or apparatus that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential features or elements of the technology describes herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after that application is filed. Accordingly the reader should consult the application as filed for the original content of the disclosure. Any deletion of content of the disclosure should not be construed as a disclaimer, forfeiture or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

```
TABLE 1
Copyright (c) The Regents of the University of California
MOTOR.CPP
#include “Motor.h”
Motor::Motor(int control_pin)
{
  this->control_pin = control_pin;
  pinMode(this->control_pin, OUTPUT);
  digitalWrite(this->control_pin, HIGH); // turn off the motor in initialization
  this->use_sensor = false;
}
Motor::Motor(int control_pin, int sensor_pin)
{
  this->control_pin = control_pin;
  this->sensor_pin = sensor_pin;
  pinMode(this->control_pin, OUTPUT);
  pinMode(this->sensor_pin, INPUT_PULLUP);
  digitalWrite(this->control_pin, HIGH); // turn off the motor in initialization
  this->use_sensor = true;
}
void Motor::start( )
{
  digitalWrite(this->control_pin, LOW);
}
void Motor::stop( )
{
  digitalWrite(this->control_pin, HIGH);
}
void Motor::rotate_n_seconds(float time)
/*
rotate the motor for time seconds
args
time: rotating time in seconds
*/
{
  unsigned long start_time = millis( );
  while ((millis( ) − start_time) < time * 1000)
  {
    start( );
  }
    stop( );
}
void Motor::rotate_n_loop(int loop_n, float delay_time)
{
  unsigned long loop_time = millis( );
  if (this->use_sensor)
  {
    int loop = 0;
    bool touch_reset = false;
    while (loop < loop_n)
    {
      start( );
      if ((millis( ) − loop_time) > delay_time * 1000)
      {
        touch_reset = digitalRead(this->sensor_pin);
        Serial.printIn(“touch_reset: ” + String(touch_reset));
        if (touch_reset == LOW)
        {
          loop += 1;
          loop_time = millis( );
        }
      }
    }
    stop( );
  }
}
Motor::~Motor( ){ }
```

TABLE 2

```
Copyright (c) The Regents of the University of California
MOTOR.H
#ifndef MOTOR_H
#define MOTOR_H
#include “Arduino.h”
class Motor
{
public:
  Motor(int control_pin);
  Motor(int control_pin, int sensor_pin);
  ~Motor( );
  void rotate_n_seconds(float time);
  void rotate_n_loop(int loop_n, float delay_time=0.5);
  void start( );
  void stop( );
  int control_pin;
  int sensor_pin;
  bool use_sensor;
};
#endif
```

```
TABLE 3
Copyright (c) The Regents of the University of California
SHAKER-V2.INO
/*
Saliva shaker
This code is for driving the saliva shaker
  The circuit:
  * Shaker motor M1
  * Rotator motor M2
  * Photosensor P1 and P2
  * Relay board
  created 2021
  by Zhenghao Fei
  Bioautomation lab, UC Davis
  */
#include “Motor.h”
// constants won't change. They're used here to
// set pin numbers:
const int M1_SHAKER = 2; // the shaker motor control pin
const int M2_ROTATOR = 3; // the rotator motor control pin
const int P1 = 4; // the first photo detector pin
const int B_RUN = 5; // the run button pin
const int B_ROTATE = 6; // the rotate button pin
Motor shaker_motor(M1_SHAKER);
Motor rotator_motor(M2_ROTATOR, P1);
void setup( )
{
  pinMode(B_RUN, INPUT_PULLUP);
  pinMode(B_ROTATE, INPUT_PULLUP);
  Serial.begin(9600);
}
void loop( )
{
  // read the state of the pushbutton values:
  bool button_state_run = digitalRead(B_RUN);
  bool button_state_rotate = digitalRead(B_ROTATE);
  bool sensor_state_P1 = digitalRead(P1);
  // check if the pushbutton is pressed.
  // if it is, the buttonState is HIGH:
  Serial.printIn(“button_state_run: ” + String(button_state_run));
  Serial.printIn(“button_state_rotate: ” + String(button_state_rotate));
  Serial.printIn(“sensor_state_P1: ” + String(sensor_state_P1));
  // Run Loop
  if (button_state_run == LOW)
  {
    for (int i = 0; i < 60; ++i)
    {
      Serial.printIn(“Loop (“ + String(i) + ”/10)”);
      Serial.printIn(“Shaking”);
      shaker_motor.rotate_n_seconds(3.0);
      delay(500);
      Serial.printIn(“Rotating”);
      rotator_motor.rotate_n_loop(1, 0.5);
      delay(500);
    }
  }
  // Rotate
  if (button_state_rotate == LOW)
  {
      Serial.printIn(“Rotating”);
      rotator_motor.rotate_n_loop(1, 0.5);
  }
}
```

TABLE 4
Parts List

| ITEM | | | |
|---|---|---|---|
| NO. | PART NUMBER | DESCRIPTION | QTY. |
| 1 | 80/20 Beams | Type 1010 Beams, various lengths | 17 |
| 2 | Shaker Motor Mounting Plate | Shaker Motor Mounting Plate | 1 |
| 3 | 6409K26 | Gearmotor to rotate carriage | 1 |
| 4 | 2709K16 | Gearmotor to oscillate carriage | 1 |
| 5 | Shaft Collar for Pins | Collar to engage pins | 1 |
| 6 | Shaft Collar with Pins | Collar with pins | 1 |
| 7 | Crank Disk | Disk for slider/crank Mechanism | 1 |
| 8 | 2434K543 | Threaded Rod End Bolt | 1 |
| 9 | 7421K1 | Low Friction Thrust Bearing | 4 |
| 10 | Crank Plate | Crank Plate | 1 |
| 11 | 91273A168 | Shoulder Bolt, ¼″ diameter | 1 |
| 12 | 91273A171 | Shoulder Bolt, ¼″ diameter | 1 |
| 13 | 5905K21 | Needle Roller Bearing | 2 |
| 14 | 97135A215 | Locknut, ¼-28 | 1 |
| 15 | Gusset Bracket 4 hole | 80/20 Corner Brackets | 10 |
| | 10 series | | |
| 16 | 47065T239 | 4 Hole Corner Bracket | 10 |
| 17 | Slotted Sensor | Infrared photodiode sensor | 1 |
| | OPB815WZ | | |
| 18 | IR Sensor Mounting Block | Mounting Block for IR sensor | 1 |
| 19 | MSHXNUT 0.190-32-S-N | Hex Nuts, 10-32 | 37 |
| 20 | shaker motor cover plate | Polycarbonate plate | 1 |
| 21 | spit motor cover plate | Polycarbonate plate | 1 |
| 22 | Suction Cup Mounting Plate | Attaches suction cups to frame | 4 |
| 23 | 53535A23 | Suction cup feet | 8 |
| 24 | 6374K126 | Linear Sleeve Bearing | 2 |
| 25 | Bearing Plate Spit End | Mounting Plate for linear bearing | 2 |
| 26 | Rotation Cap | Delrin cap | 1 |
| 27 | Shaft Endpiece Shaker End | Collar for Rotation Cap | 1 |
| 28 | Retaining Ring Shaker End | Retaining ring for Rotation Cap | 1 |
| 29 | 5 × 2 | Aluminum joining plate | 4 |
| 30 | .5 × 20″ | Shaft | 1 |
| 31 | 9677T21 | Face mount shaft collar | 2 |
| 32 | Tray Plate 8 Cartridge Version | Aluminum plate for cartridges | 2 |
| 33 | Cartridge 5 × 3p36 × 2p5 | Sample Cartridge | 8 |
| 34 | .5 × .5 × 10.5 | Cartridge retaining bars | 4 |
| 35 | DRAW LATCH | Locking Draw Latch | 4 |
| | MC4567A14 | | |
| 36 | Sponge Rubber p5 inch thick | ½″ thick sponge rubber pad | 4 |
| 37 | Second Cartridge Hinge | Mounting plate for hinges | 2 |
| | Mounting Plate | | |
| 38 | Hinge Half MC1488A12 | Hinge | 8 |
| 39 | Second Cartridge Clamping Bar | Aluminum rectangular channel | 4 |
| 40 | Second Cartridge | Block to mount latch hook | 4 |
| | Latch Hook Block | | |
| 41 | Second Cartridge | Mounting plate for latches | 2 |
| | Latch Mounting Plate | | |
| 42 | HX-SHCS 0.138- | Screws, 8-32 × ¾″ | 16 |
| | 32 × 0.75 × 0.75-N | | |
| 43 | Second Cartridge C- Channel | C-Channel for mounting plates | 2 |
| 44 | CR-FHMS 0.19- | Screws, 10-32 × 1.25 inch | 16 |
| | 32 × 1.25 × 1-N | | |
| 45 | Second Spit Motor Mounting | Mounting Plate for item #3 | 1 |
| | Plate V2 | | |
| 46 | Photo Interrupt Plate | Plate to break IR beam | 1 |
| | for Shaker 2 | | |

What is claimed is:

1. An apparatus for mixing fluids, comprising:
(a) a carrier configured to retain one or more containers of fluids to be mixed;
(b) a mechanism configured to oscillate the carrier along a longitudinal axis;
(c) a mechanism configured to rotate the carrier around the longitudinal axis; and
(d) a controller configured to control rotation and oscillation of the carrier.

2. The apparatus of claim 1, wherein said mechanism configured to rotate the carrier along a longitudinal axis comprises:
a shaft with a central longitudinal axis, said carrier mounted to said shaft;
a rotational motor with an output;
a coupling operably connected to said shaft and to said motor output, said coupling configured to rotate said shaft around its central longitudinal axis, said coupling configured to rotate said shaft while it oscillates between a first position and a second position along the longitudinal axis;
wherein said coupling allows the shaft to translate freely at the same time as it is rotated by the rotational motor.

3. The apparatus of claim 2, wherein said coupling comprises a dual-prong sliding coupling.

4. The apparatus of claim 1, wherein said mechanism configured to oscillate the carrier along a longitudinal axis comprises:
a shaft with a central longitudinal axis, said carrier mounted to said shaft;
a motor with an output; and
a coupling operably connected to said shaft and to said motor output, said coupling configured to oscillate said shaft along said longitudinal axis between a first position and a second position, said coupling configured to oscillate said shaft while the shaft rotates around said longitudinal axis.

5. The apparatus of claim 4, wherein said coupling comprises a crank slider mechanism configured to move said shaft along said longitudinal axis between a first position and a second position;
wherein said coupling allows the shaft to freely rotate at the same time as the shaft is moved linearly along the longitudinal axis by the motor output.

6. The apparatus of claim 1, wherein said carrier comprises:
a carrier platform with a top surface; and
one or more clamps configured to secure said containers of fluids to be mixed to the top surface of the carrier platform;
wherein oscillation or rotation of the carrier platform will impart motion to said fluids to mix the fluids within the containers.

7. The apparatus of claim 1, wherein said carrier comprises:
a carrier platform with a top surface and a bottom surface;
one or more clamps configured to secure said containers of fluids to be mixed to the top surface of the carrier platform; and
one or more clamps configured to secure said containers of fluids to be mixed to the bottom surface of the carrier platform;
wherein oscillation or rotation of the carrier platform will impart motion to said fluids to mix the fluids within the containers.

8. The apparatus of claim 7, wherein said clamp comprises:
at least one left side wall coupled to the platform;
at least one right side wall coupled to the platform; and
one or more elongate clamping bars coupled at one end to a side wall with a hinge and to an opposing side wall with a latch;
wherein latching of each clamping bar is configured to secure said one or more containers to the top surface of the platform.

9. The apparatus of claim 8, wherein said clamp comprises:
at least one left side wall coupled to the platform;
at least one right side wall coupled to the platform;
one or more first elongate clamping bars coupled at one end to a side wall with a hinge and to an opposing side wall with a latch; and
one or more second elongate clamping bars coupled at one end to a side wall with a hinge and to an opposing side wall with a latch;
wherein latching of each of said first clamping bars is configured to secure said one or more containers to the top surface of the platform; and
wherein latching of each of said second clamping bars is configured to secure said one or more containers to the bottom surface of the platform.

10. The apparatus of claim 1, wherein said controller controls motion of the carrier, said motion selected from the group consisting of oscillation motion, rotational motion, simultaneous oscillation motion and rotational motion, and sequenced oscillation and rotational motion.

11. An apparatus for mixing viscous fluids through rotational and oscillating motions, the apparatus comprising:
(a) a carrier platform with top and bottom surfaces with clamps configured to retain enclosed trays containing a plurality of containers with fluids to be mixed on said top and bottom surfaces of said carrier platform;
(b) a mechanism configured to impart rotational motion to the carrier platform around a longitudinal axis for rotation of the carrier platform;
(c) a mechanism configured to impart oscillating motion to the carrier platform along the longitudinal axis; and
(d) a controller configured to control degree of rotational and oscillating motions of the carrier;
(e) wherein the controller is programmable to oscillate and rotate the carrier platform in various desired sequences, durations and frequencies.

12. The apparatus of claim 11, wherein said mechanism configured to rotate the carrier along a longitudinal axis comprises:
a shaft with a central longitudinal axis, said carrier mounted to said shaft;
a rotational motor with an output;
a coupling operably connected to said shaft and to said motor output, said coupling configured to rotate said shaft around its central longitudinal axis, said coupling configured to rotate said shaft while it oscillates between a first position and a second position along the longitudinal axis;
wherein said coupling allows the shaft to translate freely at the same time as it is rotated by the rotational motor.

13. The apparatus of claim 12, wherein said coupling comprises a dual-prong sliding coupling.

14. The apparatus of claim 11, wherein said mechanism configured to oscillate the carrier along a longitudinal axis comprises:
a shaft with a central longitudinal axis, said carrier mounted to said shaft;
a motor with an output;
a coupling operably connected to said shaft and to said motor output, said coupling configured to oscillate said shaft along said longitudinal axis between a first position and a second position, said coupling configured to oscillate said shaft while the shaft rotates around said longitudinal axis.

15. The apparatus of claim 14, wherein said coupling comprises a crank slider mechanism configured to move said shaft along said longitudinal axis between a first position and a second position;
wherein said coupling allows the shaft to freely rotate at the same time as the shaft is moved linearly along the longitudinal axis by the motor output.

16. An apparatus for mixing viscous fluids through rotational and oscillating motions, the apparatus comprising:
(a) a carrier configured to retain a plurality of containers with liquid samples to be mixed;
(b) a shaft with a central longitudinal axis, said carrier mounted to said shaft;
(c) a rotation coupling operably connected to a first end of said shaft and to a rotational motor output, said rotation coupling configured to rotate said shaft around its central longitudinal axis;
(d) a translation coupling operably connected to a second end of said shaft and to a translation motor output, said translation coupling configured to oscillate said shaft along said longitudinal axis between a first position and a second position; and
(e) a controller configured to control rotational and oscillating motions of the shaft;
(f) wherein said rotation coupling is configured to rotate said shaft while it oscillates between a first position and a second position along the longitudinal axis; and
(g) wherein said translation coupling is configured to oscillate said shaft while the shaft rotates around said longitudinal axis.

17. The apparatus of claim 16, wherein said controller controls motion of the carrier, said motion selected from the group consisting of oscillation motion, rotational motion, simultaneous oscillation motion and rotational motion, and sequenced oscillation and rotational motion.

18. The apparatus of claim 16, wherein said carrier comprises:
a carrier platform with a top surface; and
one or more clamps configured to secure said containers of fluids to be mixed to the top surface of the carrier platform;
wherein oscillation or rotation of the carrier platform will impart motion to said fluids to mix the fluids within the containers.

19. The apparatus of claim 16, wherein said carrier comprises:
a carrier platform with a top surface and a bottom surface;
one or more clamps configured to secure said containers of fluids to be mixed to the top surface of the carrier platform; and
one or more clamps configured to secure said containers of fluids to be mixed to the bottom surface of the carrier platform;
wherein oscillation or rotation of the carrier platform will impart motion to said fluids to mix the fluids within the containers.

20. A method of mixing viscous fluids through rotational and shaking motion, the method comprising:
(a) providing the apparatus of any of claim 1, 11, or 16; and
(b) imparting motion to the carrier wherein said motion is selected from the group consisting of oscillating motion, rotational motion, simultaneous oscillation motion and rotational motion, and sequenced oscillating and rotational motion.
